(19) United States
(12) Patent Application Publication
(10) Pub. No.: US 2010/0180754 A1
(43) Pub. Date: Jul. 22, 2010

(54) System and method of enhancing control of a portable music device

(76) Inventors: William J. Brown, Centereach, NY (US); Len Novara, Miller Place, NY (US); Christopher Wanless, Rocky Point, NY (US); Christopher Griswold, Sound Beach, NY (US)

Correspondence Address: Thomas A. O'Rourke;Bodner & O'Rourke, LLP, 425 Broadhollow Road, Melville, NY, 11747, US

(21) Appl. No.: 12/321,599

(22) Filed: Jan. 22, 2009

(51) Int. Cl. G10H 1/36

(52) U.S. Cl. 84/610

(57) ABSTRACT

A portable device is disclosed for use with an audio or video content provider to establish hands-free control of the available functions of the content provider. The device may include a microphone interface to receive an electric signal from an integral or an externally plugged in microphone which, through use of a processor, may permit digitization of the signals, and comparison to a template of digital signals representing known voice commands that may be transmitted to the content provider. Non-volatile memory utilized in conjunction with the processor enables extended customization capabilities which are retained for later use, even after the device has been powered off. Operation of the device may alternatively occur according to default factory settings, or user programmed custom settings. Customizable features may include user trained voice commands, volume settings, sound effects, voice recognition thresholds, tone settings, and album lists.

### FIELD OF THE INVENTION

The present invention is directed to improvements to music players such as an iPod and the like.

### BACKGROUND OF THE INVENTION

Digital music players have become very popular over the last few years. In particular, portable music players that can play music, audio books and video content are becoming ubiquitous as memory capacity increases and gets less expensive. There are also other devices such as GPS navigation systems available that may include music, video, and linkages to cell phones.

An increasing number of vehicles today permit a portable music player to be electronically connected to a car's entertainment system. One of the issues in a driving environment where a player is used, is that the driver can become distracted and increase the risk of an accident, much like the increased risk of speaking on a cell phone while driving. The user must concentrate on the player's controls to operate the portable music player, diverting attention from the road or other activities.

In addition, there are many situations where a person wants to listen to audio content, but he or she is doing some physical activity or may be wearing gloves which may make it difficult, or even dangerous to operate the music player's controls.

People with disabilities who want to listen to music or recorded books or some other audio content, or view video content, but for whom it is impossible to otherwise operate the music player's control, would find a hands-free method of controlling the music player very useful.

Although some devices, in particular certain audio devices, are equipped with and include with its purchase, a hand-held remote control, use of the remote control again poses increased risk for an accident as the user necessarily will have to search through a glove box or center console or otherwise reach around to find the control. Also, there will invariable be the need to glance down at the remote control to punch the proper keys to provide inputs to the music player or other electronic device.

As a result, there is a need for a device that is either built-into, or that attaches to an audio/video content provider such as a portable music player, GPS device and the like, that permits hands-free voice activated control of that player.

### SUMMARY OF THE INVENTION

The present invention is directed to a device for a variety of players including, but not limited, to music players such as MP3 devices and the like, video players, GPS systems, etc. This device may be a separate attachment for the device or may be integral to the device, through installation during the device's manufacture.

The present invention is a system that would attach to a device, such as a portable music player and the like, that permits the device to be voice activated by a user, and controlled through voice commands, permitting hands-free operation of the device.

### BRIEF DESCRIPTION OF THE DRAWINGS

FIGS. 1A and 1B is a schematic of a preferred embodiment of the present invention.

FIG. 2 is a functional block diagram of the present invention.

FIG. 3 is a flow chart of the initialization procedure of the present invention.

FIG. 4 is a flow chart of the executive loop of the present invention.

FIG. 5 is a flow chart detailing system logic of the present invention when a keyword is detected.

FIG. 6 is a flow chart detailing system logic of the present invention where an exception is detected while listening.

FIG. 7 is a flow chart detailing system logic of the present invention where an utterance is detected.

FIG. 8 is a flow chart detailing system logic of the present invention where the user has manually intervened in the hands-free control of the unit.

FIG. 9 is a flow chart of the basic menu operations available for the present invention.

FIG. 10 is a flow chart of the advanced menu operations for the present invention.

FIG. 11 is a flow chart detailing system logic of the present invention where the user trains the unit to recognize a single utterance.

FIG. 12A and 12B is a flow chart detailing system logic of the present invention where the user trains the unit to recognize a voice command.

FIG. 13 is a flow chart of the voice training menu of the present invention.

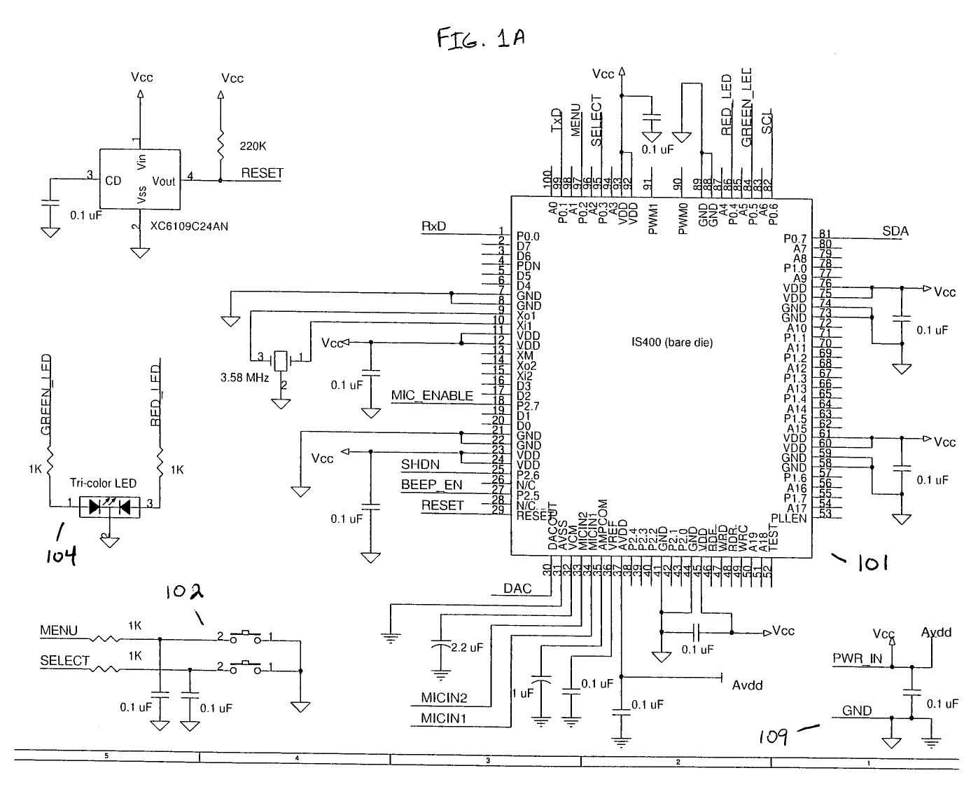

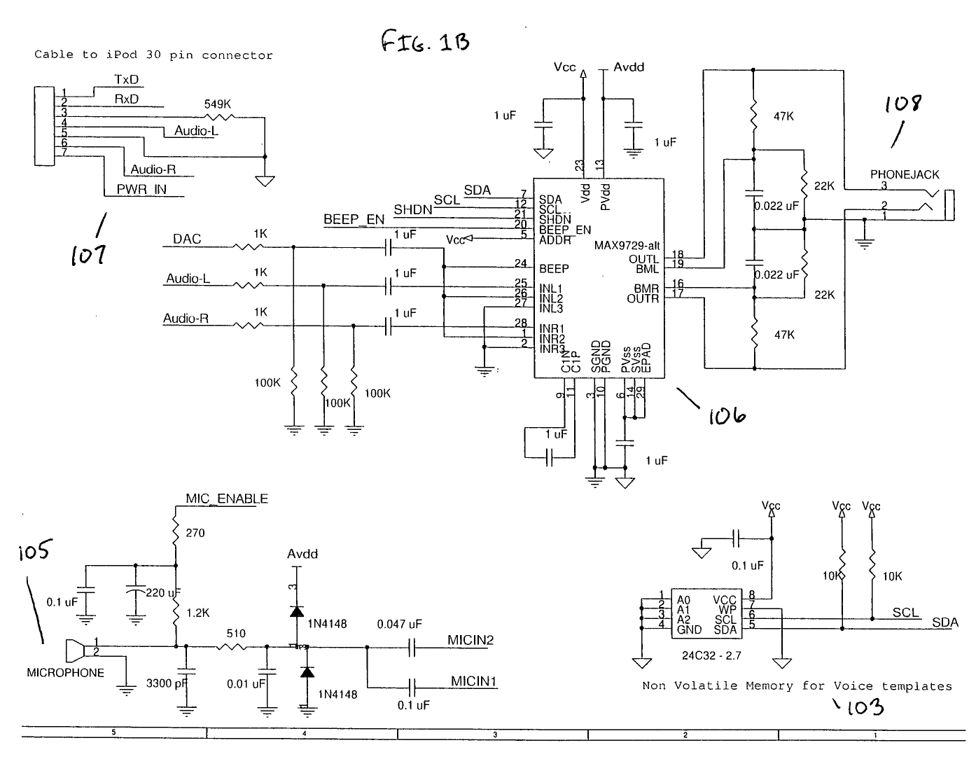

### DETAILED DESCRIPTION OF THE INVENTION

The use and proliferation of portable music players has increased dramatically over the past few years. This invention will aid the user who owns a portable music player or other playing device, including but not limited to audio/video players, GPS systems, etc. The present invention assists a user who, for a variety of reasons, can not conveniently or safely access the controls of the player. Reasons for these restrictions could be, but are not limited to, users who are involved in an activity that precludes the use of their hands such as driving, skiing, walking or jogging, or riding a bicycle. The user may also be disabled and unable to use his or her hands.

Players such as music players typically have a user interface consisting of buttons click-wheels, or touch panels or screens. Many music players also have ports for the attachment of accessories. This invention could add voice recognition control capabilities to such players.

The preferred embodiment could comprise a system that would attach to the portable music player that would include a processor and interface with the player. It may also contain one or more controls, indicators, and a built-in microphone interface, which could utilize either an integral or a plug-in external microphone. The device may also have an interface for the connection of headphones. The present invention may also include a pass-through connector for situations where the invention would fit between the portable music player and some other accessory such as, but not limited to, a boom-box.

The preferred embodiment would take power from the portable music player or the pass-through accessory, but it could also be self-powered. The self-powered embodiment may comprise an adaptor to utilize household current, or batteries, which may be rechargeable through a variety of sources.

The device will utilize voice recognition as one method of controlling the portable music player. Other methods could include the reception of wireless digital information from another device using mediums such as, but not limited to, Infrared, Radio, or audible control packet technology.

In the preferred embodiment, the user will issue voice commands to effect the operation of the attached music player. The device will interpret these voice commands and issue control sequences to the portable music player to execute the desired voice commands. These voice commands can be, but are not limited to, “play,” “pause,” “stop,” “next track,” “previous track” “next album,” “previous album,” “volume up,” “volume down,” “fast-forward,” “rewind,” etc.

In order to reduce the incidence of false positive responses due to other noises in the area, the preferred embodiment could require the use of keywords that need to be detected before it will respond to one of the command words. The device can inject an audible signal mixed into audio content of the portable music player to indicate to the user that it understood the keyword.

The device will be able to operate without the need to train it, but a preferred embodiment of this invention may also have the ability to be trained to respond to a particular user. This would be necessary in situations where the user has some unusual tonal quality or accent that reduces the recognition accuracy of the out-of-box voice commands.

In a preferred embodiment, the user may be prompted with oral instructions throughout the training process to make training as easy as possible. In the preferred embodiment, the trained commands are saved in non-volatile memory so that they are retained even when the unit is not connected to a power source, or just powered off.

The device of the present invention may preferably be an attachment that connects to a player. The user plugs the headphones into the device and the device is plugged into the player's accessory port. The user can then talk to the device. In one embodiment, a Keyword indicator will come on indicating that the device is listening for a keyword to activate the system. There may be a default or factory keyword to start the system. The user says the keyword, and the device will inject a sound effect into the headphone indicating that it understood the keyword. This sound effect may be mixed with the device's audio content, and it may be selectable to be either a bleep, a double tic, or nothing at all by having the user select his or her preferences.

An indicator light such as a green light indicates that the device is listening for a command word. A user has a time interval to utter a voice command. In one preferred embodiment the user will initially have 5 seconds to say one of the command words. If a valid command word is spoken within the initial time interval the device will act on the command and give the user an additional time interval, say 15 seconds, to say another command without the need to repeat the keyword. If the user doesn't say a command word in the 1^{st} interval the device will quietly revert to listening for a keyword. If the device has detected a valid voice commands and the extended time interval expires, it will inject the listening-for-keyword sound effect into the audio stream. This 2 tier system should filter out extraneous intrusions into the device's audio content in the event of a false positive response to the keyword. Typical voice commands can include: Play Music, Stop Music, Next Track, Previous Track, Next Album, Previous Album, Next Playlist, Previous Play list, Volume up, Volume down, and Shuffle.

A preferred embodiment of this invention is equipped to permit Menu operation whereby the user may select or adjust parameters in creating a customized mode of operation for the device. The custom mode of operation may remain active for successive uses of the device, unless the mode is altered, or unless the user selects the default, pre-programmed mode of operation.

There are preferably two buttons on the device of the preferred embodiment One button may be designated MENU, and one may be SELECT. Pressing SELECT by itself simulates the device detecting the detection of a keyword. It will make the selected keyword sound, and the device will start listening for a command. Pressing SELECT again will make it revert to simply listening for the keyword. Pressing the MENU button briefly may permit manual playing of the music player to which it is connected. By pressing and holding the MENU button, the user may access a menu system, and the attached music player may be paused. The user may be prompted through the headphones to set a variety of user preferences. The user may advance through the menu options by pressing the MENU button. The user may adjust a menu item by pressing the SELECT button. Items that may be adjusted through the menu system could be, but are not limited to, adjusting the volume, training the unit for voice commands, using or ignoring the trained voice commands, adjusting the listening time and modes, adjusting the keyword sound effect, adjusting the recognition threshold, adjusting the tone, or resetting the device to its factory settings.

The user may adjust a menu item by pressing the SELECT button. The user also may advance through menu options by pressing the MENU button. If the user does not press a button after a preset interval, such as 10 seconds, the device will say “goodbye” and exit the menu system.

In a preferred embodiment of the invention, the device may periodically check the battery level of the player. If a threshold level of battery usage is reached, the device will announce, through the headphones, that the battery is low.

All user preferences, including the last headphone volume, may be saved in non-volatile memory. Training of the unit may be accomplished by the user. When training is selected, the device may prompt the user to say the keyword and each voice command in sequence. The user may skip over commands that he doesn't want to re-train by pressing the Menu button. In the preferred embodiment the user will be asked to say each word twice to ensure it was stated clearly.

The device may check that your voice commands are unique. If a trained voice command sounds too much like another command, the user may be prompted to choose a different word. The user may use any voice command desired, and it may be in any language.

The device of the preferred embodiment may have both preset and trained commands. If a trained voice commands exists, the user will have the option to ignore the trained command or to use the out-of-box, factory commands. This eliminates the need for a command to erase trained words, if the user lends the device to someone. A user may select the built-in voice commands and when the device is returned to its owner, the user may select the previously trained words. Trained words can always be retained for a new user.

The preferred embodiment may also possess bass boost capability. The headphone amplifier may have the ability to boost the low end to make inexpensive earbuds sound better.

The preferred embodiment of the present invention may also be provided with Keyword sound effects, such that when the device “hears” a keyword, it will preferably provide feedback in the headphones in addition to lighting the LEDs. This type of feedback is optional. It can be a bleep, a tic or nothing at all. False positive keywords could interfere with music play which is why several levels of intrusion are available.

The ability of the device to “hear” or recognize verbal commands may be adjusted to several different threshold settings.

A “reset to factory defaults” menu item may be provided as a way to reset the device to its factory default settings and erase any trained voice commands. In the preferred embodiment, the user is asked to press the SELECT button again to prevent accidental erasure of the users settings.

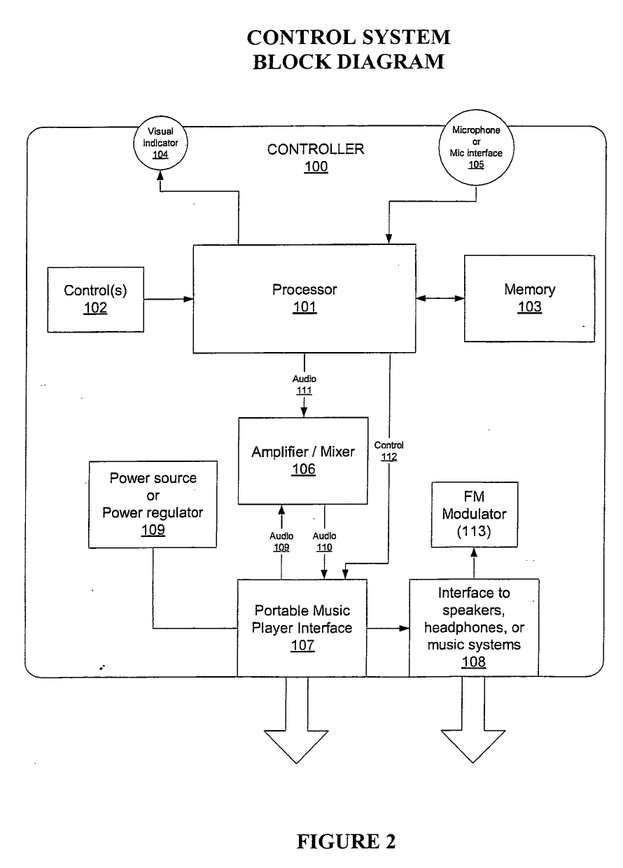

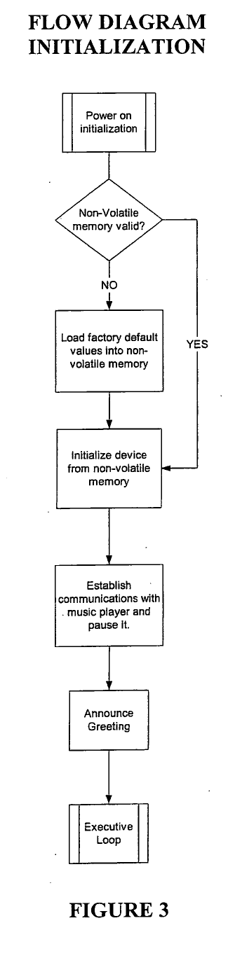

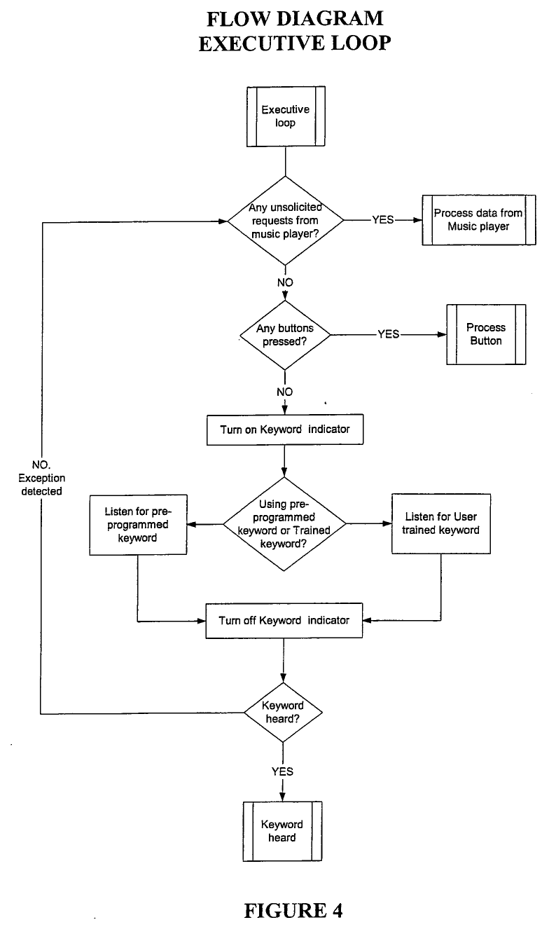

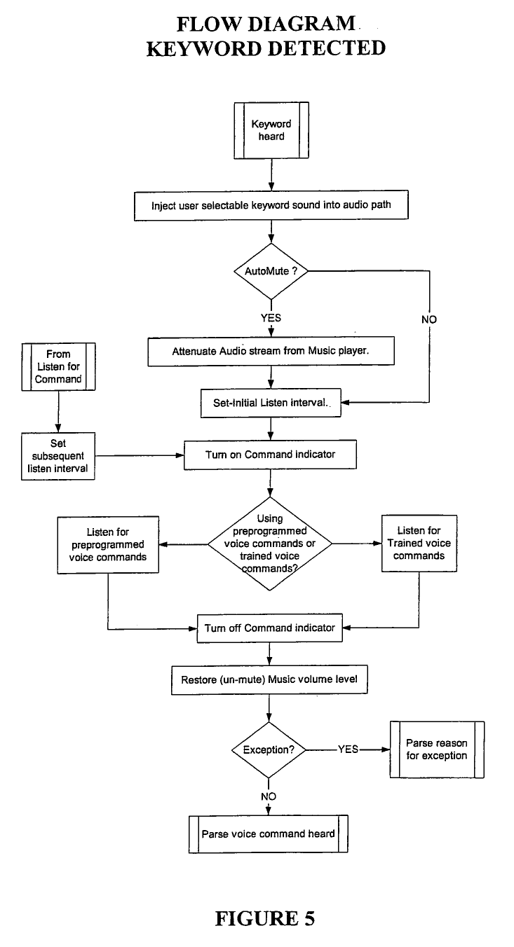

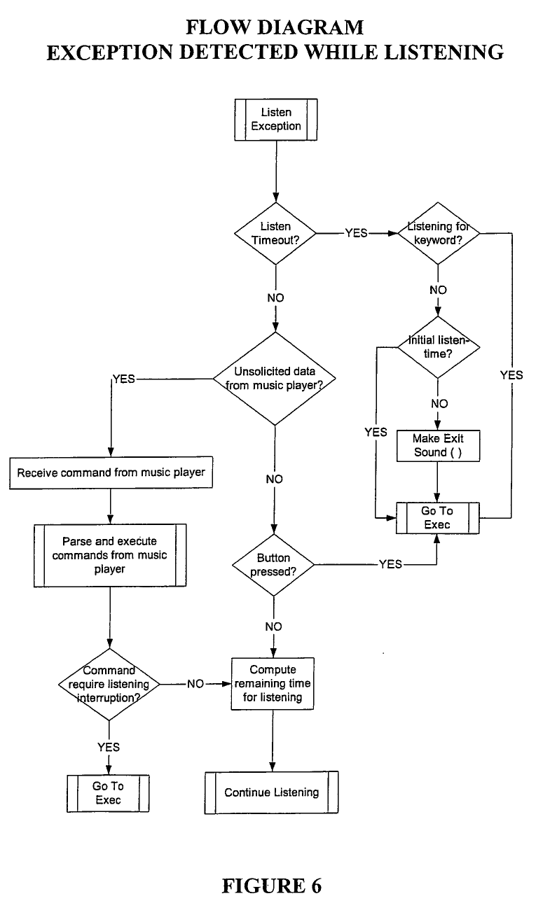

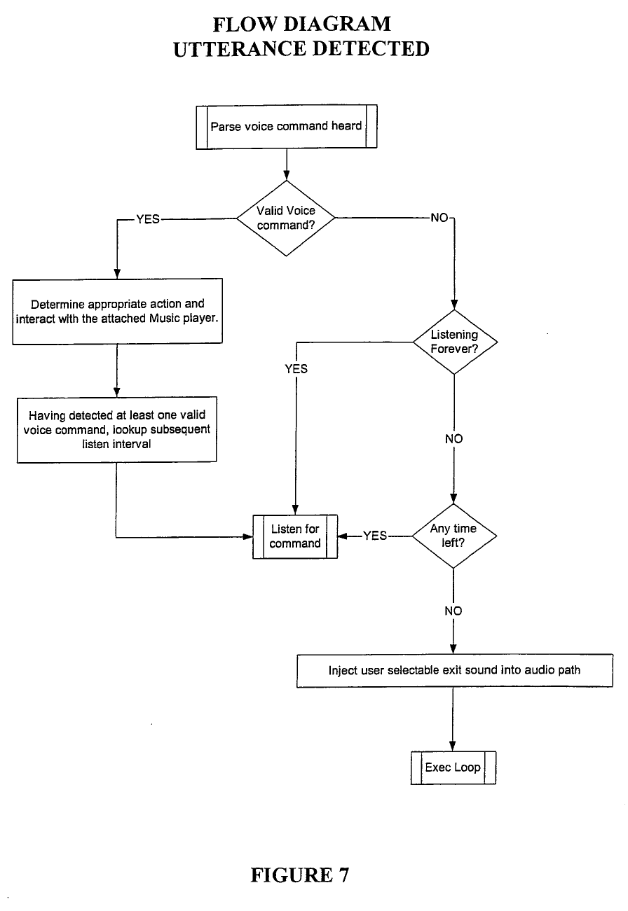

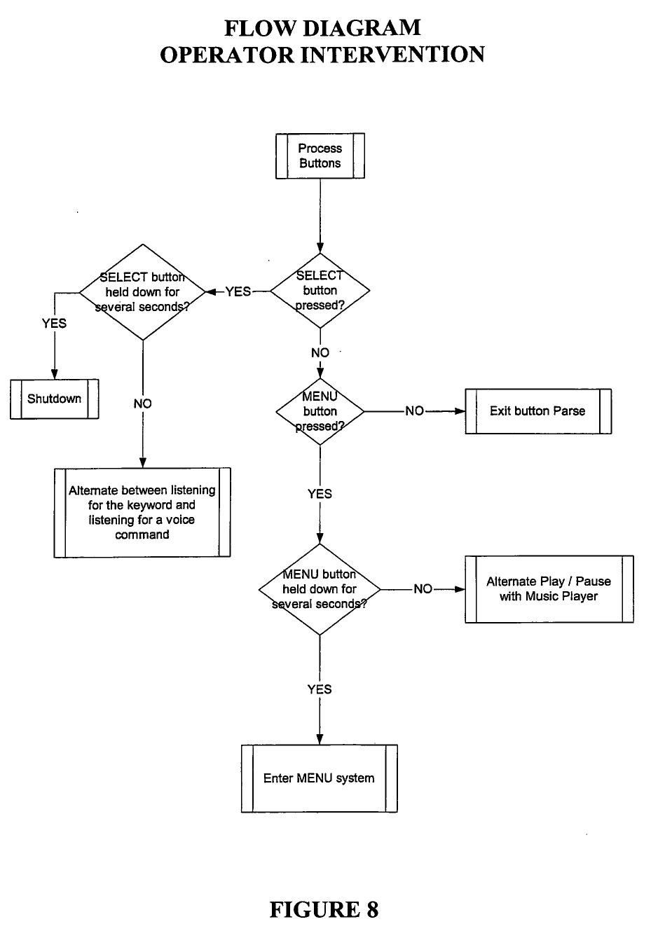

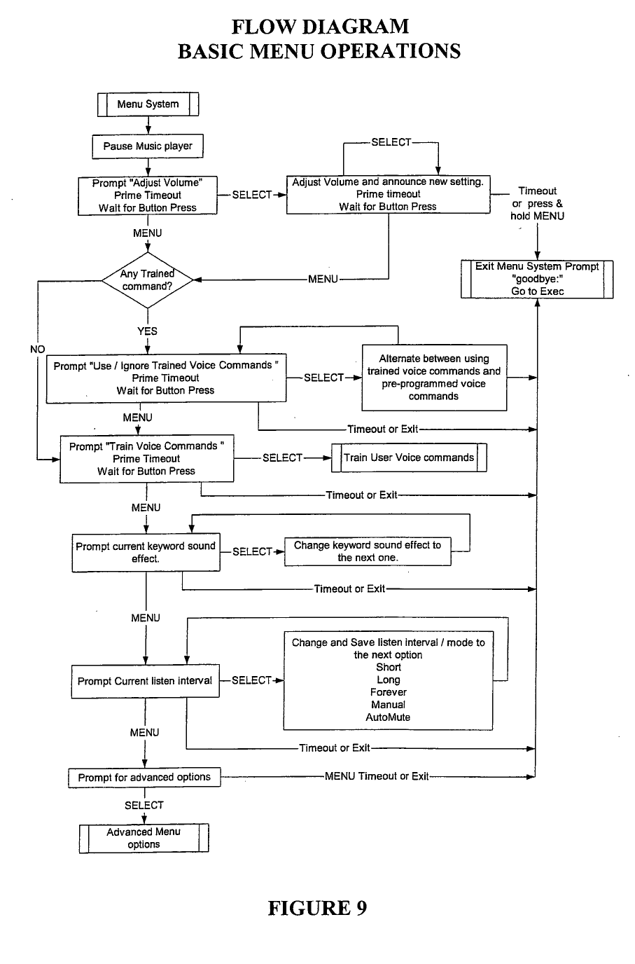

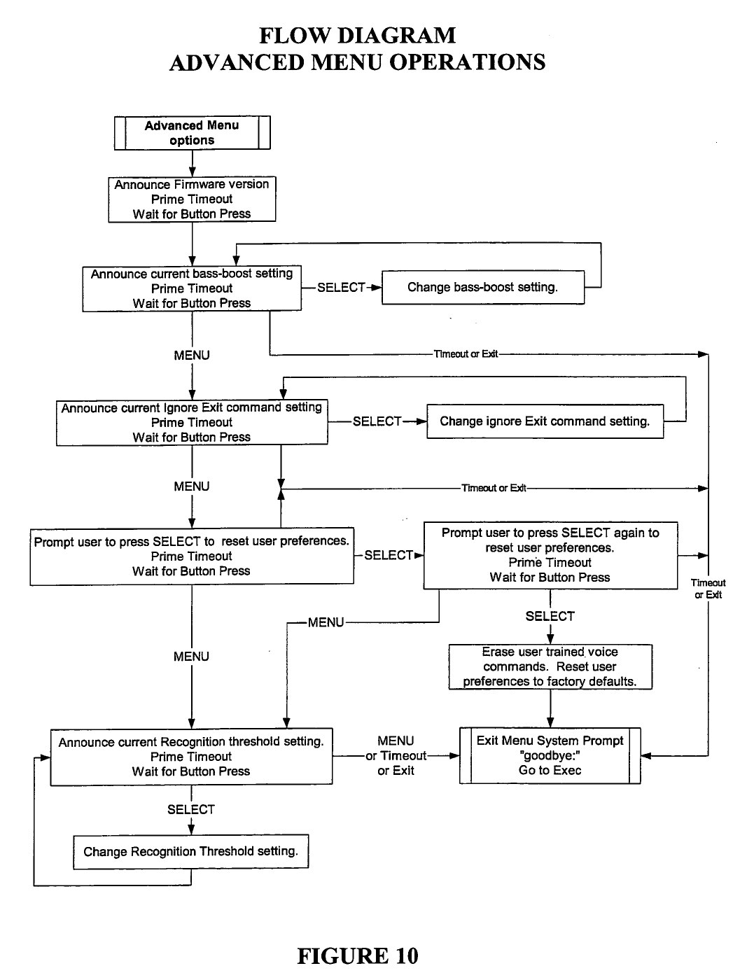

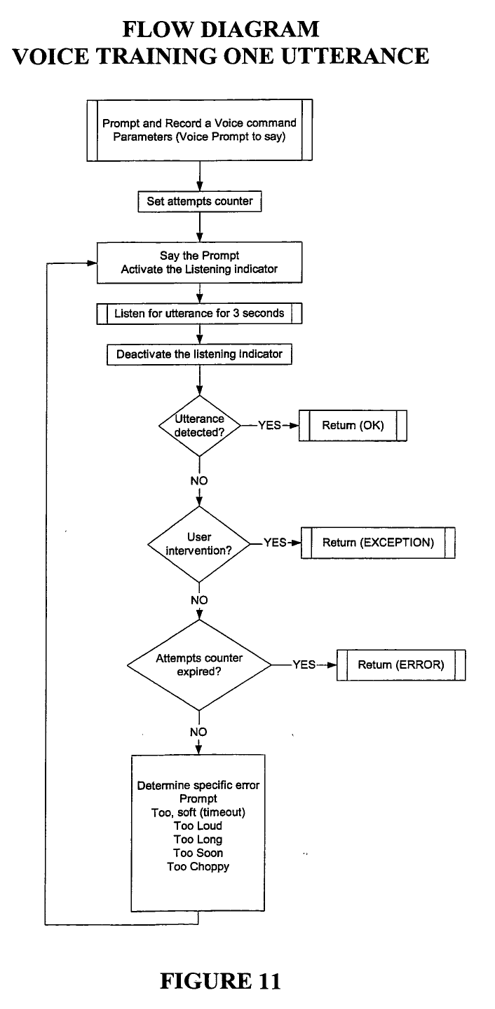

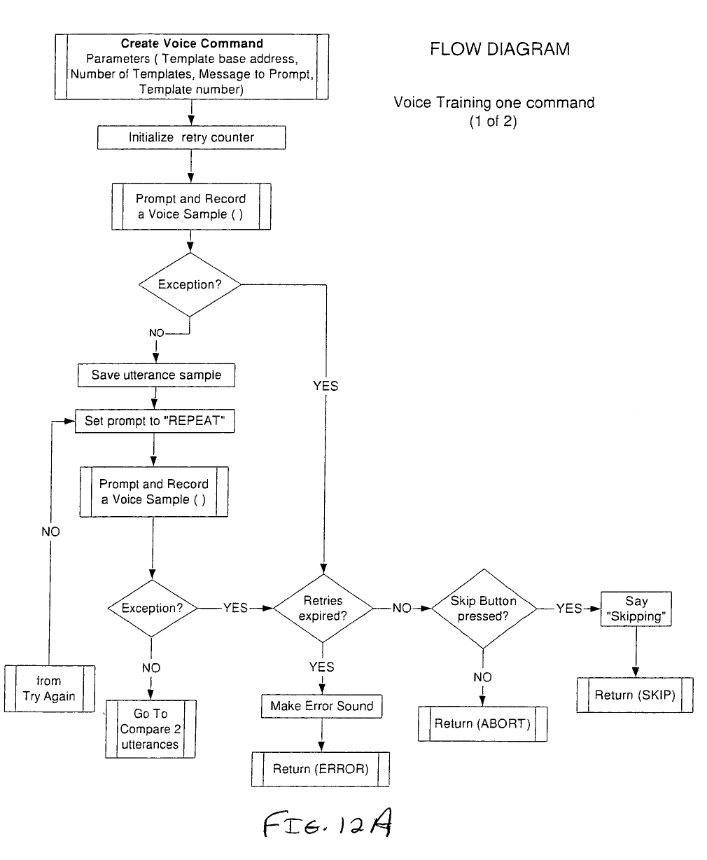

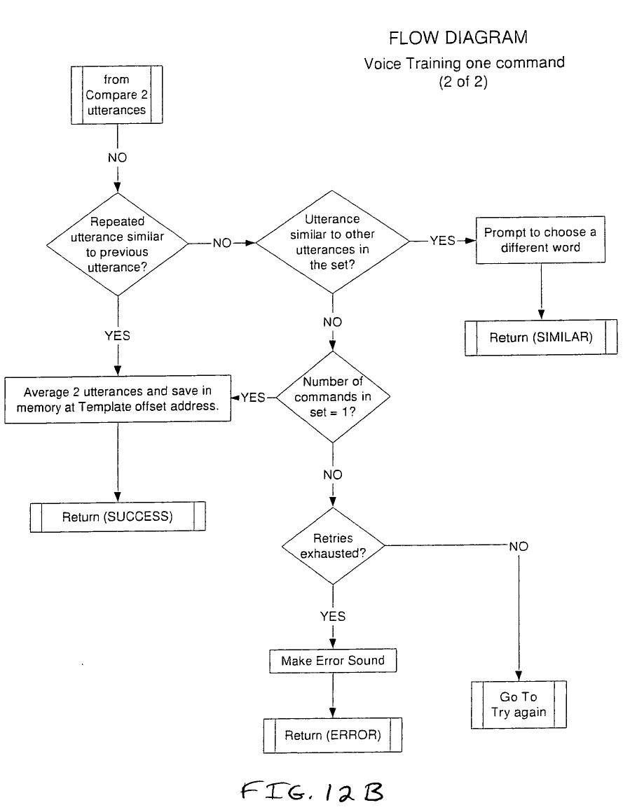

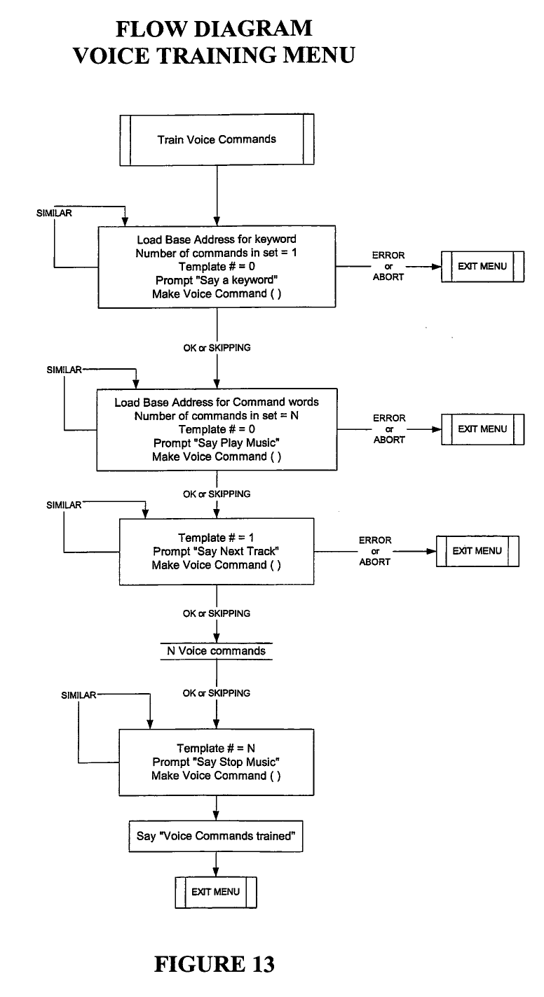

The functional block diagram of FIG. 2 shows a preferred embodiment where the device is a controller 100 and is made to be as small and light as possible, so it can be worn on the person using it. The controller of the preferred embodiment may contain a built in microphone 105 or an interface to accommodate a plug-in external microphone. This microphone converts the user's spoken commands from acoustic energy into electrical energy. The electrical energy represents sounds within the microphones range. This electrical energy is delivered to a processor where it is sampled, and digitized-converted into a stream of numbers. The processor will interpret the digital signals and compare them to known templates of numbers representing the voice commands that the device is programmed to interpret. The processor may contain a central processing unit 101, internal memory 103, and peripheral input/output ports. The I/O ports may connect to devices such as the microphone 105, the visual indicators 104, which may be a bi-colored Light Emitting Diode (LED) in the current embodiment, but alternatively could be any type of indicator. Other I/O ports connect to the device's controls 102 which, in the current embodiment, consist of 2 momentary push-buttons. The momentary push-button generally being a “push-to-make” switch, which makes contact when the button is pressed and breaks contact when the button is released. The processor 101 may also be connected to non-volatile memory 103 which could be built into the processor, but may also, as in the current embodiment, be external to the processor. This memory 103 is retained even in the absence of power. This memory may be used to save user preferences and trained voice commands. The processor may also be capable of synthesizing sounds which can be injected into the music player's content 111. These sounds consist of sound effects that indicate an event such as the detection of a keyword, or they may consist of spoken prompts that instruct the user how to perform certain tasks such as training voice commands or changing user preferences. The synthesized audio may be sent as an analog time-varying voltage 111 into an amplifier and mixer 106. The amplifier/mixer may also receive audio content from the attached music player through the music player interface 107. The audio 109 from the music player and the synthesized audio 111 from the processor may be combined in the amplifier/mixer 106 and be delivered as a combined audio output 110 via the music player 107 to the interface 108, which may be earphones, speakers, or to an optional attached FM modulator 113 for delivery directly to a nearby FM radio. The music player interface 107 may provides a control interface 112 through which the processor and the attached music player may exchange digital control information. The Music player interface may also supply power to the voice controller or it can be self powered.

The examples and descriptions provided are simply provided to illustrate a preferred embodiment of the present invention. Those skilled in the art and having the benefit of the present disclosure will appreciate that further embodiments may be implemented with various changes within the scope of the present invention.

What is claimed is:

1. A portable device for use with an audio or video content provider to establish hands-free control of available functions of a content provider, said device comprising:
a) a microphone interface, said microphone interface capable of receiving an electric signal;
b) a processor, said processor capable of receiving and converting said electrical signal transmitted from said microphone interface into a digital signal, said processor being capable of comparing said digital signals to a template of signals representing known commands, said processor capable of outputting a known command;
c) non-volatile memory, said non-volatile memory capable of storing parameters received from said processor, said non-volatile memory also capable of supplying said parameters to said processor to be utilized as a custom start-up setting during successive use of said device;
d) a control interface, said control interface capable of receiving audio or video signals from the content provider, said interface capable of transmitting recognized commands from said processor to the content provider; and
e) an output interface, said output interface capable of receiving said audio signal or said video signal or said combined signal from said control interface, and said output interface capable of providing output.

2. The device according to claim 1 wherein said electric signal comprises the sound of a spoken command or other audio signal converted into said electric signal, and wherein said template of signals representing known commands- comprises known voice commands.

3. The device according to claim 2 wherein said processor further comprises the capability of outputting sound effects to identify a condition of said device.

4. The device according to claim 3 wherein said condition comprises one of the current operating modes of said device: verification of input to said device; notification that the device is listening for a command; notification that said device is listening for a keyword, said keyword serving as a prerequisite before said device responds to a command; and recognition of a keyword.

5. The device according to claim 4 wherein said device further comprises an amplifier/mixer, said amplifier/mixer being capable of receiving said audio or said video signals from said control interface, said amplifier/mixer being capable of receiving said sound effects, said amplifier/mixer also capable of combining said audio or said video signal with said sound effects and outputting said combined signal to said control interface.

6. The device according to claim 1 wherein said parameter comprises a listening preference;

7. The device according to claim 6 wherein said listening preference comprises volume settings, sound effects, listening times, listening modes, voice recognition thresholds, tone settings, album lists, or factory default settings.

8. The device according to claim 1 wherein said parameter comprises a custom voice command, and wherein said custom voice command is inputted into said device during a training mode.

9. The device according to claim 8 wherein said voice command must be spoken twice to be accepted by said device.

10. The device according to claim 9 wherein said trained voice command is compared to existing commands, said trained voice command being accepted by said device if said trained voice command is different from existing commands.

11. The device according to claim 1 wherein said device further comprises device controls, said device controls permitting access to a menu of device options.

12. The device according to claim 11 wherein said device controls further comprise one or more momentary push buttons.

13. The device according to claim 11 wherein said device options further comprise muting, requirement of a keyword before acceptance of commands, pre-programmed voice commands, trained voice commands, sound effects, and the listen interval.

14. The device according to claim 13 wherein said listen interval option comprises short, long, forever, and a manually inputted time interval.

15. The device according to claim 1 wherein said processor is also capable of outputting oral prompts, said oral prompts comprising instructions to operate said device.

16. The device according to claim 1 wherein said microphone interface receives said electric signal from a plug-in external microphone.

17. The device according to claim 1 wherein said microphone interface further comprises a microphone integral to the device, said microphone interface receiving said electric signal from said integral microphone.

18. The device according to claim 1 wherein said device further comprises visual indicators to signify the mode of the device.

19. The device according to claim 18 wherein said indicators signify a command was received.

20. The device according to claim 19 wherein said indicators signify the device is in listen mode.

21. The device according to claim 20 wherein said indicators are a bi-colored Light Emitting Diode.

22. The device according to claim 1 wherein said device is self-powered.

23. The device according to claim 22 wherein said self-powered device is battery powered.

24. The device according to claim 23 wherein said device detects and announces low battery power.

25. The device according to claim 1 wherein said device is powered by the content provider to which it supplies hands-free commands.

26. The device according to claim 25 wherein said power from said content provider is supplied through said control interface.

27. The device according to claim 1 wherein said non-volatile memory is integral to said processor.

28. The device according to claim 1 wherein said non-volatile memory is external to said processor.

29. The device according to claim 1 wherein said output comprises capability of delivery to headphones, earphones, speakers, a music system.

30. The device according to claim 29 wherein said device further comprises an FM modulator, and wherein said output further comprises delivery to an FM radio.

31. The device according to claim 1 wherein said device is built into an audio or video content provider.

32. The device according to claim 1 wherein a cable from said control interface of said device plugs into an accessory port of the content provider.

33 The device according to claim 1 wherein said device is connected to an iPod to provide hands-free control of the iPod.

34. The device according to claim 1 wherein said device is capable of being worn by the user.

35. The device according to claim 1 wherein said device may be operated in two or more modes, and where said modes comprise a factory default setting, and custom settings.

36. A portable device for use with an audio or video content provider to establish hands-free control of available functions of a content provider, said device comprising:
a) a microphone interface, said microphone interface capable of receiving an electric signal, said electric signal comprising the sound of a spoken command or a video signal converted into said electric signal;
b) a processor, said processor capable of receiving and converting said electrical signal transmitted from said microphone interface into a digital signal, said processor being capable of comparing said digital signals to a template of signals representing known voice commands, said processor capable of outputting a known command;
c) an control interface, said control interface capable of receiving audio or video signals from the content provider, said interface capable of transmitting recognized commands from said processor to the content provider; and
d) an output interface, said output interface capable of receiving said audio signal or said video signal or said combined signal from said control interface, and said output interface capable of providing output.
